(19) United States
(12) Patent Application Publication
(10) Pub. No.: US 2006/0169741 A1
(43) Pub. Date: Aug. 3, 2006

(54) Self-clamping device for friction stir spot welding

(75) Inventors: Christopher B. Smith, Sussex, WI (US); Bryan F. Orsini, Burlington, WI (US)

Correspondence Address: MICHAEL BEST & FRIEDRICH, LLP, 100 E WISCONSIN AVENUE, MILWAUKEE, WI, 53202, US

(73) Assignee: Friction Stir Link, Inc., Menomonee Falls, WI (US)

(21) Appl. No.: 11/344,898

(22) Filed: Feb. 1, 2006

Related U.S. Application Data
(60) Provisional application No. 60/648,794, filed on Feb. 1, 2005.

(51) Int. Cl. B23K 37/00; B23K 20/12

(52) U.S. Cl. 228/2.1; 228/44.3

(57) ABSTRACT

A friction stir spot welding device includes a tool head configured for traveling in a first direction towards a workpiece and in a second direction away from the workpiece. A weld tool is rotatably coupled relative to the tool head and includes a free end. The weld tool travels in concert with the tool head. A clamping mechanism is supported by the tool head and substantially surrounds at least the weld tool. The clamping mechanism travels in concert with the tool head and includes a free end defining a contact surface. A portion of the clamping mechanism is movable relative to the tool head between a first position, in which the contact surface is positioned further from the tool head than the free end of the weld tool, and a second position, in which the contact surface is positioned closer to the tool head than the free end of the weld tool. Biasing means bias the clamping mechanism to the first position.

### CROSS-REFERENCE TO RELATED APPLICATIONS

This application claims priority from U.S. Provisional Patent Application No. 60/648,794, entitled “Self-Clamping Device for Friction Stir Spot Welding”, filed Feb. 1, 2005 by Christopher B. Smith and Bryan F. Orsini.

### BACKGROUND

The present invention relates to a self-clamping device for improved friction stir spot welding.

The process of friction stir spot welding is used for joining workpieces disposed adjacent to one another and attaching the two workpieces. The friction stir welding device includes a rotatable shaft with a free end including a shoulder and a pin-like projection that extends from the shoulder. To form a spot weld, the pin is rotated at a high speed and is forced into the workpieces at a single point until the rotating shoulder contacts an upper surface of the workpieces. Friction between the rotating tool and the uppermost workpiece, as well as heat from the pin, plasticizes and softens the metal in a weld region surrounding the pin. The pin is removed from the workpieces after the hot, plasticized metal from the two workpieces mixes together to form a spot weld and thereby attach the two workpieces together. After cooling and hardening, a fine grained, hot worked weld point that is strong and resistant to breaking is left.

High forces are associated with friction stir spot welding. The high forces can lift or deform material outside the weld region as the pin enters into the workpieces. Methods are known for reducing lift and deformation of material in and around the weld region, although these methods have disadvantages. One method is to modify the tool geometry of the friction stir spot welding device or weld schedule modifications, however, often lower weld strengths or slower process speeds result.

Another method includes local clamping around the welding location and in other locations. Clamping is used to hold the workpieces in relational position. Typically, in friction stir spot welding the density of clamping is less than the number of single point joints that are required.

### SUMMARY

In one embodiment, the invention provides a friction stir spot welding device including a tool head configured for traveling in a first direction towards a workpiece and in a second direction away from the workpiece. A weld tool rotatably is coupled relative to the tool head and includes a free end. The weld tool travels in concert with the tool head. A clamping mechanism is supported by the tool head and substantially surrounds at least the weld tool. The clamping mechanism travels in concert with the tool head and includes a free end defining a contact surface. A portion of the clamping mechanism is movable relative to the tool head between a first position, in which the contact surface is positioned further from the tool head than the free end of the weld tool, and a second position, in which the contact surface is positioned closer to the tool head than the free end of the weld tool. Biasing means bias the clamping mechanism to the first position.

In another embodiment, the invention provides a friction stir spot welding device including a tool head configured for traveling in a first direction towards a workpiece and in a second direction away from the workpiece and a weld tool rotatably coupled relative to the tool head. The weld tool includes a free end and travels in concert with the tool head. A clamping mechanism is supported by the tool head and substantially surrounds at least the weld tool. The clamping mechanism includes a free end defining a contact surface, wherein the clamping mechanism travels in concert with the tool head. Biasing means bias a portion of the clamping mechanism to a first position in which the contact surface is positioned further from the tool head than the free end of the weld tool. When the contact surface of the clamping mechanism contacts a workpiece, the biasing means is overcome such that the clamping mechanism moves to a second position in which the contact surface is positioned closer to the tool head than the free end of the weld tool and the contact surface remains in contact with the workpiece.

In yet another embodiment, the invention provides a self-clamping device for a friction stir spot welding device. The self-clamping device includes a slide plate is movably coupled to a tool head of the friction stir spot welding device, the slide plate movable between a first position and a second position. Biasing means are positioned between the slide plate and the tool head wherein the biasing means bias the slide plate to the first position. A clamp sleeve extending from the slide plate, the clamp sleeve defining a contact surface, wherein when the slide plate is in the first position, the contact surface is closer to the mounting plate than when the slide plate is in the second position.

Other aspects of the invention will become apparent by consideration of the detailed description and accompanying drawings.

### BRIEF DESCRIPTION OF THE DRAWINGS

FIG. 1 illustrates a friction stir spot welding device, including a main tool head and a self-clamping device.

FIG. 2 is a side view of a main tool head and a self-clamping device according to one embodiment of the invention.

FIG. 3 is a sectional view of the main tool head and the self-clamping device of FIG. 2.

FIG. 4 is an end view of the self-clamping device of FIG. 2.

FIG. 5 is a schematic diagram of a sectional view of a self-clamping device according to one embodiment of the invention.

FIG. 6 is a schematic diagram of a sectional view of a free end of the self-clamping device of FIG. 5 illustrating a spot weld process.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

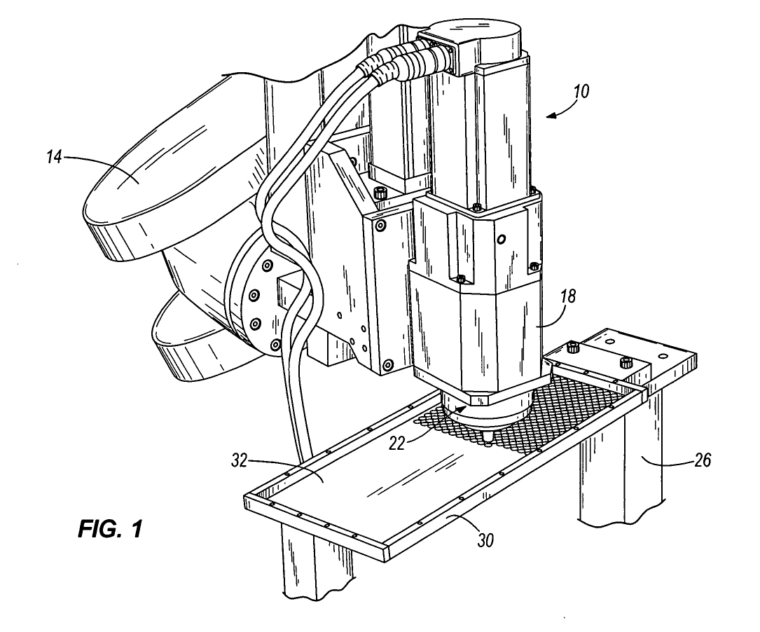

FIG. 1 illustrates a friction stir spot welding device 10 mounted to a robotic arm 14. The friction stir spot welding device 10 includes a main tool head 18, or spindle housing, and a self-clamping device 22, or clamping mechanism, coupled to a tool end of the tool head. A base 26 and a workpiece support 30, or backing, supported by the base 26 support workpieces 32 to be friction stir spot welded. In a further embodiment, the workpiece support 30 may be provided by a C-frame, as is generally use with resistance spot welding and riveting applications. It should be readily apparent to those of skill in the art that the self-clamping device 22 may be used with a robotic or non-robotic friction stir spot welding device.

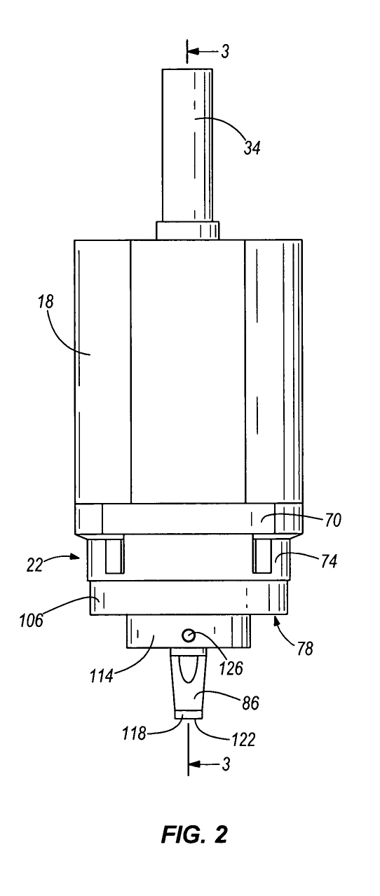

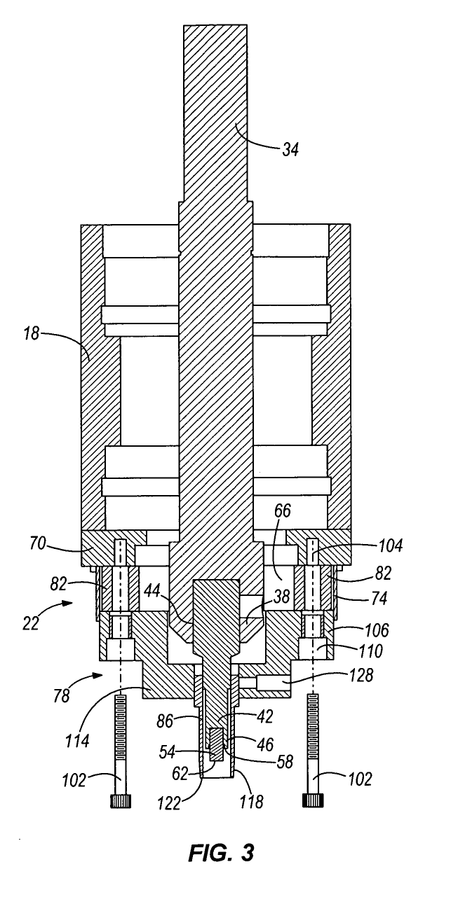

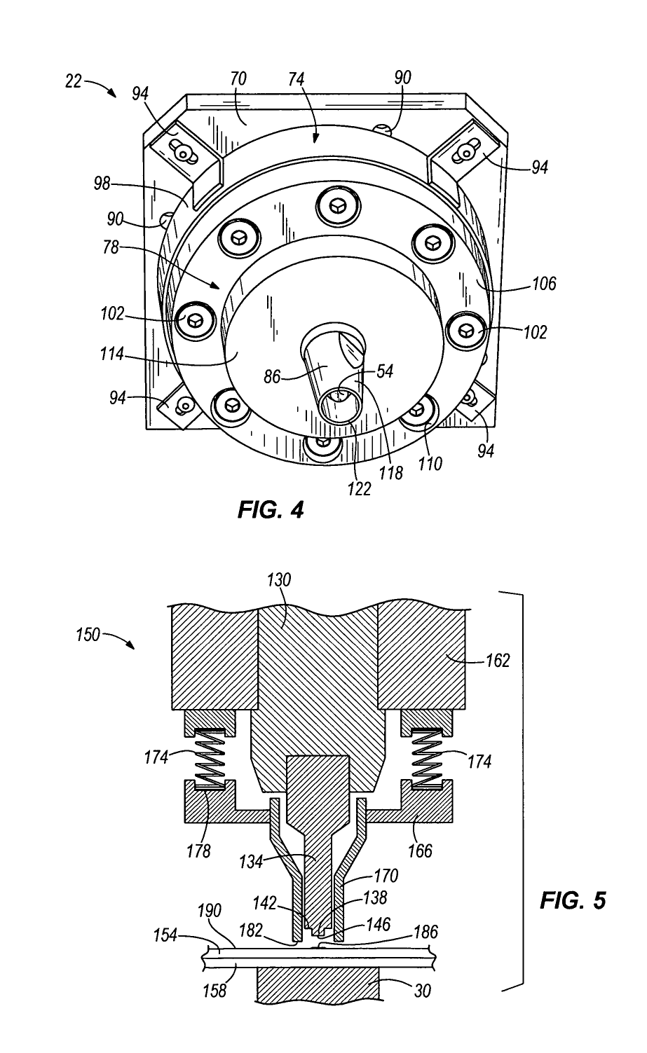

FIGS. 2 and 3 illustrate one embodiment of the main tool head 18 and the self-clamping device 22, and FIG. 4 illustrates the self-clamping device 22 detached from the tool head 18. The tool head 18 includes a rotatable spindle 34 that extends through the tool head 18 and includes a tool end 38. A weld tool 42 is coupled to the tool end 38 of the spindle 34 and rotates with the spindle 34. The weld tool 42 includes one end received by a bore 44 to the spindle 34 and a free end 46. The free end 46 of the weld tool 42 has a pin-like projection 54 (FIG. 3), i.e., weld pin, which may be separate from the weld tool 42. The weld pin 54 extends from a shoulder 58 defined by the weld tool 42 and is coupled to the weld tool 42. The weld pin 54 defines a contact surface 62 for the weld tool 42.

The friction stir spot welding device 10 includes the self-clamping device 22 coupled to the main tool head 18. The self-clamping device 22 defines a center bore 66 (FIG. 3) that the spindle 34, the weld tool 42 and the weld pin 54 are positioned within, such that the self-clamping device 22 substantially surrounds a portion of the spindle 34, the weld tool 42 and the weld pin 54. In the illustrated embodiment, the self-clamping device 22 does not rotate with the spindle 34. In operation, the tool head 18 moves toward the workpiece support 30 in a first direction (i.e., vertically downward in the Figures) and away from the workpiece support 30 in a second direction (i.e., vertically upward in the Figures), whereby the self-clamping device 22 coupled to the tool head 18 travels in concert with the tool head 18 and the weld tool 42.

The self-clamping device 22 includes a mounting plate 70, a shield 74, a slide plate 78, biasing springs 82, and a clamp cone 86. The mounting plate 70, or base portion, supports the components of the self-clamping device 22 and is coupled to the main tool head 18 to attach the self-clamping device 22 to the tool head 18. The mounting plate 70 is generally square and includes apertures 90 (FIG. 4) for receiving fasteners (not shown) to couple the self-clamping device 22 to the tool head 18. The shield 74 is a generally cylindrical tube and includes four shield angles 94 mounted to an outer surface 98 of the shield, for example, by welding. The shield angles 94 are used to couple the shield 74 to the mounting plate 70. It should be readily apparent to those of skill in the art that any number of fasteners and shield angles 94 may be used to couple the self-clamping device 22 to the tool head 18 and the shield 74 to the mounting plate 70, respectively.

The slide plate 78 is coupled to the mounting plate 70 by shoulder bolts 102 (FIG. 4) and is configured to fit within the shield 74. Apertures 104 (FIG. 3) formed in the mounting plate 70 receive the bolts 102. The slide plate 78 includes a first portion 106 having a first diameter and eight apertures 110 for receiving the shoulder bolts 102, and a second portion 114 having a second diameter smaller than the first diameter. The biasing springs 82 are positioned within the shield 74 and between the first portion 106 of the slide plate 78 and the mounting plate 70. It should be readily apparent to those of skill in the art that the clamping mechanism does not need to include the mounting plate. In such an embodiment, the slide plate is coupled directly to the main tool head 18, or spindle housing, and the biasing springs are positioned between the slid plate 78 and the main tool head 18. In the illustrated embodiment, eight compression springs 82 are used and each spring 82 is aligned with one aperture 104 of the mounting plate 70 and one aperture 110 of the slide plate 78 such that the respective shoulder bolt 102 passes through the spring 82. The shoulder bolt 102 operates as a guidance mechanism for the respective spring 82.

In another embodiment of the self-clamping device 22, fewer or more springs 82 and shoulder bolts 102 may be used. Further, it should be readily apparent to those of skill in the art that other types of biasing members may be used instead of compression springs, such as an air spring, an elastomer, or the like, or that the springs are pre-loaded, and that other types of guidance mechanisms may be used, such as screws, pins, dowels, linear bearings, or the like. In yet another embodiment, guidance mechanisms are not used with the springs.

The clamp cone 86, or sleeve, is a generally cylindrical tube and includes a free end 118 and an opposite end retained within the center bore 66 defined by the second portion 114 of the slide plate 78. The free end 118 of the clamp cone 86 defines a contact surface 122. A set screw 126 (FIG. 2) is received by a bore 128 (FIG. 3) of the second portion 114 of the slide plate 78. The set screw 126 secures the clamp cone 86 in position within the bore 66. In the illustrated embodiment, the clamp cone 86 has a diameter smaller than the second diameter of the slide plate 78.

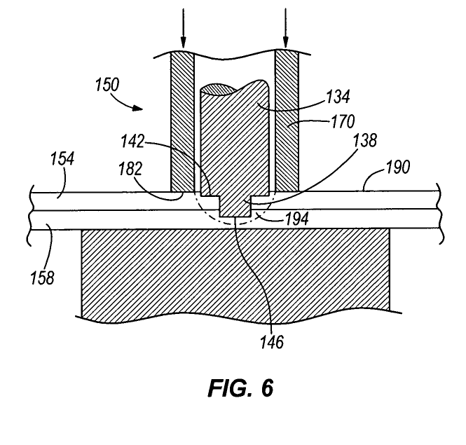

As shown in FIG. 3, the spindle 34 and the weld tool 42 extend through the center bore 66 defined by the self-clamping device 22. In the illustrated embodiment, a portion of the weld tool 42 and the weld pin 54 are positioned within the clamp cone 86. The slide plate 78, and thereby the clamp cone 86, is movable between a first position (FIGS. 2-4), in which the contact surface 122 of the clamp cone 86 is positioned further from the main tool head 18 than the contact surface 62 of the weld pin 54, and a second position, in which the contact surface 122 of the clamp cone 86 is positioned closer to the tool head 18 than the contact surface 62 of the weld pin 54. The springs 82 bias the slide plate 78 and the clamp cone 86 to the first position and away from the tool head 18. In use (as further described below with respect to FIGS. 5 and 6), as the main tool head 18 is moved in a first direction toward the workpiece support 30, the contact surface 122 of the self-clamping device 22 contacts two workpieces to be spot welded together. The slide plate 78 and the clamp cone 86 overcome the bias of springs 82 and move to the second position such that the weld pin 54 can enter the workpieces as the self-clamping device 22 holds the workpieces in position. Further, the springs 82 provide a clamping force for holding the two workpieces together as the weld pin 54 enters the workpieces. This operation is described further below with respect to FIGS. 5 and 6.

Forces exerted by the self-clamping device 22 prevent relational movement between the workpieces and trap the workpieces together such that weld material does not flow between the workpieces, thereby preventing lifting and other deformations of the workpieces during the spot weld process. As the weld pin 54 enters the workpieces at the weld point and the rotating shoulder 58 contacts the workpieces, the clamp cone 86 pushes against the workpieces to provide a counter-force in the weld region surrounding the weld pin 54. Such a counter-force prevents the material from moving, lifting upward or deforming during the spot weld process.

FIGS. 5 and 6 schematically illustrate use of one embodiment of a self-clamping device for friction stir spot welding and use with the friction stir spot welding device 10. The method of operation described with respect to FIGS. 5 and 6 also applies to a method of operating the self-clamping device 22 described above with FIGS. 2-4. A main tool head (not shown) includes a rotating spindle 130 and a weld tool 134 attached to the spindle 130, which rotates with the spindle 130. The weld tool 134 includes a pin-like projection 138, i.e., a weld pin, extending from a shoulder 142 defined by the weld tool 134. The weld pin 138 defines a contact surface 146 for the weld tool 134.

A self-clamping device 150 is coupled to the main tool head and substantially surrounds the weld tool 134 and a portion of the spindle 130. In the illustrated embodiment, the self-clamping device 150 remains stationary and does not rotate with the spindle 130. The tool head, and thereby the weld tool 134, moves toward and away from an upper workpiece 154, or sheet, and a lower workpiece 158, or sheet, supported by the workpiece support 30. The self-clamping device 150 is coupled to the tool head and travels in concert with the weld tool 134.

Referring to FIG. 5, the self-clamping device 150 includes a mounting portion 162 that attaches to the main tool head (not shown), a body portion 166, and a clamp sleeve 170 (or cone or ring) integral with the body portion 166 that surrounds the weld tool 134. In the illustrated embodiment, two compression springs 174 are positioned between a top surface 178 of the body portion 166 and the mounting portion 162, however, in further embodiments fewer or more springs may be used. The springs 174 are coupled to the mounting portion 162 and the body portion 166, and the springs 174 bias the clamp sleeve 170 substantially vertically downward, i.e., away from the tool head. In a further embodiment, the body portion 166 is coupled to the mounting portion 162 and the self-clamping device 150 includes guidance mechanisms for use with springs 174 as described above with respect to FIG. 3. The clamp sleeve 170 travels in concert with the weld tool 134 as the tool head travels in a first direction toward the workpieces 154, 158. The clamp sleeve 170 includes a free end defining a contact surface 182 for interfacing with the upper workpiece 154 to be welded.

The friction stir spot welding device 10 is used to spot weld and attach together two workpieces 154, 158. In the embodiment illustrated in FIGS. 5 and 6, the upper workpiece 154 is stacked on the lower workpiece 158 and the friction stir spot welding device 10 attaches the upper and lower workpieces 154, 158 together with at least one spot weld. In a further embodiment, the friction stir spot welding device 10 is used to attach together two adjacent workpieces along a weld joint.

In operation, the main tool head (not shown) and the weld tool 134 are moved in the first direction towards a spot weld point 186 on the upper workpiece 154. The springs 174 provide a reactive force to bias the clamp sleeve 170 downward and away from the tool head to the first position. In the first position, the contact surface 182 of the clamp sleeve 170 is positioned further from the tool head than the contact surface 146 of the weld pin 138. In a further embodiment, the self-clamping device 150 includes another object to provide reactive force to the sleeve 170, such as an air spring, an elastomer or the like. During the weld process, the spindle 130 of the tool head rotates, to thereby rotate the weld tool 134, and the self-clamping device 150 remains stationary.

As seen in FIG. 6, the contact surface 182 of the clamp sleeve 170 contacts the upper workpiece 154 shortly before the weld pin 138 contacts the workpiece. The clamp sleeve 170 of the self-clamping device 150 pushes against an upper surface 190 of the upper workpiece 154 (shown by the arrows in FIG. 6) while the weld pin 138 of the weld tool 154 continues moving in the first direction and plunges into the workpieces 154, 158 at the spot weld point 186. The clamp sleeve 170 overcomes the bias of the springs 174 and moves to a second position such that the contact surface 182 of the clamp sleeve 170 is positioned closer to the tool head than the contact surface 146 of the weld pin 138. The springs 174 provide the clamping force for holding the workpieces 154, 158 in position as the weld pin 138 enters the upper workpiece 154. After the weld pin 138 enters the workpieces 154, 158, the rotating shoulder 142 contacts the upper surface 190 of the upper workpiece 154, and in some embodiments, the rotating shoulder 142 enters the upper workpiece 154. The self-clamping device 150 holds the relational position between the upper and lower workpieces 154, 158 and keeps the two workpieces 154, 158 from moving as the weld tool 134 forms the spot weld. Friction from the rotating shoulder 142 and heat from the weld pin 138 plasticizes and softens weld material at a weld region 194, or stir zone, surrounding the pin 138 and the shoulder 142.

After the weld is complete, the main tool head (not shown) and weld tool 134 move in a second direction and retract away from the workpieces 154, 158. The weld tool 134 and the weld pin 138 exit the workpieces after the hot, softened weld material from the upper and lower workpieces 154, 158 mixes together in the weld region 194 to form a spot weld between the upper and lower workpieces. After the spot weld is formed, the weld tool 134 is moved away from the two workpieces 154, 158 and then positioned above another single point joint for spot welding. It will be readily appreciated by those of skill in the art that weld tool geometry, particularly the geometry of the pin and the shoulder, defines the size and shape of the weld region, which effects strength of the spot weld. As the weld tool 134 moves in the second direction and the weld pin 138 exits the workpieces 154, 158, the springs 174 bias the clamp sleeve 170 back to the first position.

The self-clamping device of the present invention is coupled to, or integrally formed with, the main tool head of the friction stir spot welding device. Therefore, a single self-clamping device is used for multiple single point joints and multiple clamping devices are not needed. Further, because the self-clamping device moves with the weld tool in order to contact the workpieces, additional actuation is not required to position the clamp sleeve, or cone, relative to the workpieces. The self-clamping device clamps the workpieces at each spot weld without additional fixturing on the workpieces or additional actuation within the friction stir spot weld device, which is more efficient and less expensive than prior art clamp devices. Finally, the self-clamping device does not impact the cycle time of the friction stir spot welding process because the self-clamping device moves in concert with the weld tool and is not separately actuated.

The constructions and aspects described above and illustrated in the drawings are presented by way of example only and are not intended as a limitation upon the concepts and principles of the present invention. As such, it will be appreciated by one having ordinary skill in the art, that various changes in the elements and their configuration and arrangement are possible without departing from the spirit and scope of the present invention.

What is claimed is:

1. A friction stir spot welding device comprising:
a tool head configured for traveling in a first direction towards a workpiece and in a second direction away from the workpiece;
a weld tool rotatably coupled relative to the tool head, the weld tool including a free end, wherein the weld tool travels in concert with the tool head;
a clamping mechanism supported by the tool head and substantially surrounding at least the weld tool, the clamping mechanism traveling in concert with the tool head and including a free end defining a contact surface, wherein a portion of the clamping mechanism is movable relative to the tool head between a first position, in which the contact surface is positioned further from the tool head than the free end of the weld tool, and a second position, in which the contact surface is positioned closer to the tool head than the free end of the weld tool; and
biasing means for biasing the clamping mechanism to the first position.

2. The friction stir spot welding device of claim 1 wherein the weld tool includes a weld pin extending from a shoulder defined by the free end of the weld tool, and further wherein when the clamping mechanism is in the first position the contact surface is positioned further from the tool head than the weld pin.

3. The friction stir spot welding device of claim 1 wherein the clamping mechanism includes a mounting portion, which is coupled to the tool head, and a sleeve, which substantially surrounds a portion of the weld tool.

4. The friction stir spot welding device of claim 3 wherein the biasing means is positioned between the mounting portion and the sleeve.

5. The friction stir spot welding device of claim 1 wherein the clamping mechanism comprises:
a mounting plate coupled to the tool head and fixed relative to the tool head;
a shield formed by a generally cylindrical tube and coupled to the mounting plate;
a slide plate coupled to the mounting plate, the biasing means positioned within the shield and between the slide plate and the mounting plate, wherein the biasing means bias the slide plate to the first position; and
a clamp sleeve coupled to the slide plate, the clamp sleeve defining the contact surface of the clamping mechanism.

6. The friction stir spot welding device of claim 1 wherein the biasing means includes a compression spring.

7. The friction stir spot welding device of claim 6, and further comprising a fastener for coupling the clamping mechanism to the tool head and extending through a center of the compression spring.

8. The friction stir spot welding device of claim 1 wherein the clamping mechanism moves to the second position when the contact surface contacts the workpiece as the tool head moves in the first direction.

9. The friction stir spot welding device of claim 8 wherein force from the clamping mechanism holds the workpiece in position during welding.

10. The friction stir spot welding device of claim 1, and further comprising a workpiece support for supporting the workpiece and positioned from the tool head in the first direction.

11. A friction stir spot welding device comprising:
a tool head configured for traveling in a first direction towards a workpiece and in a second direction away from the workpiece;
a weld tool rotatably coupled relative to the tool head, the weld tool including a free end, wherein the weld tool travels in concert with the tool head;
a clamping mechanism supported by the tool head and substantially surrounding at least the weld tool, the clamping mechanism including a free end defining a contact surface, wherein the clamping mechanism travels in concert with the tool head;
biasing means for biasing a portion of the the clamping mechanism to a first position in which the contact surface is positioned further from the tool head than the free end of the weld tool,
wherein when the contact surface of the clamping mechanism contacts the workpiece, the biasing means is overcome such that the clamping mechanism moves to a second position in which the contact surface is positioned closer to the tool head than the free end of the weld tool and the contact surface remains in contact with the workpiece.

12. The friction stir spot welding device of claim 11 wherein the weld tool includes a weld pin extending from a shoulder defined by the free end of the weld tool, and further wherein when the clamping mechanism is in the first position the contact surface is positioned further from the tool head than the weld pin.

13. The friction stir spot welding device of claim 11 wherein the clamping mechanism includes a mounting portion that is coupled to the tool head and a sleeve that substantially surrounds a portion of the weld tool.

14. The friction stir spot welding device of claim 13 wherein the biasing means is positioned between the mounting portion and the sleeve.

15. The friction stir spot welding device of claim 11 wherein the clamping mechanism comprises:
a mounting plate coupled to the tool head and fixed relative to the tool head;
a shield formed by a generally cylindrical tube and coupled to the mounting plate;
a slide plate coupled to the mounting plate, the biasing means positioned within the shield and between the slide plate and the mounting plate, wherein the biasing means bias the slide plate to the first position; and
a clamp sleeve coupled to the slide plate, the clamp sleeve defining the contact surface of the clamping mechanism.

16. The friction stir spot welding device of claim 15, and further comprising a fastener for coupling the slide plate to the mounting plate and extending through a center of the biasing means.

17. The friction stir spot welding device of claim 11 wherein the biasing means includes a compression spring.

18. The friction stir spot welding device of claim 11 wherein when the clamping mechanism is in the second position, force from the clamping mechanism holds the workpiece in position during welding.

19. The friction stir spot welding device of claim 11 wherein when the clamping mechanism is in the second position, the weld tool enters the workpiece.

20. The friction stir spot welding device of claim 11, and further comprising a workpiece support for supporting the workpiece and positioned from the tool head in the first direction.

21. A self-clamping device for a friction stir spot welding device, the self-clamping device comprising:
a slide plate movably coupled to a tool head of the friction stir spot welding device, the slide plate being movable between a first position and a second position;
biasing means positioned between the slide plate and the tool head, the biasing means biasing the slide plate to the first position; and
a clamp sleeve extending from the slide plate, the clamp sleeve defining a contact surface,
wherein when the slide plate is in the first position, the contact surface is closer to the tool head than when the slide plate is in the second position.

22. The self-clamping device of claim 21, and further comprising a fastener for coupling the slide plate to the mounting plate, the fastener extending through a center of the biasing means.

23. The self-clamping device of claim 21 wherein the biasing means includes a compression spring.

24. The self-clamping device of claim 21, and further comprising a mounting plate for coupling to a tool head of the friction stir spot welding device, the mounting plate fixed relative to the tool head wherein the slide plate is movably coupled to the mounting plate.

25. The self-clamping device of claim 25, and further comprising a shield formed by a generally cylindrical tube and coupled to the mounting plate, wherein the biasing springs are positioned within the shield and the slide plate is at least partially received within the shield.
